(19) United States
(12) Patent Application Publication
(10) Pub. No.: US 2023/0005269 A1
(43) Pub. Date: Jan. 5, 2023

(54) METHOD AND APPARATUS FOR DETECTING REAL-TIME ABNORMALITY IN VIDEO SURVEILLANCE SYSTEM

(71) Applicant: INDUSTRY ACADEMY COOPERATION FOUNDATION SEJONG UNIVERSITY, Seoul (KR)

(72) Inventors: Young Gab KIM, Seoul (KR); Yu Jun KIM, Seoul (KR)

(21) Appl. No.: 17/853,875

(22) Filed: Jun. 29, 2022

(30) Foreign Application Priority Data
Jun. 30, 2021 (KR) 10-2021-0085994

(51) Int. Cl. G06V 20/52; G06T 7/00; G06V 10/77

(52) U.S. Cl. CPC G06V 20/52; G06T 7/0002; G06V 10/7715; G06T 2207/10016; G06T 2207/20084

(57) ABSTRACT

The present disclosure provides a method and apparatus for detecting an abnormal event from a monitoring image accurately and speedily in a video surveillance system. A method of detecting an abnormal event in a series of temporally successive images includes: generating a predicted current frame based on a previous frame temporally ahead of an actual current frame and a subsequent frame temporally behind the actual current frame; calculating an anomaly score indicating a difference between the predicted current frame and the actual current frame; and determining that an abnormality is included in the actual current frame when the anomaly score satisfies a predetermined condition.

### CROSS-REFERENCE TO RELATED APPLICATION

The present application claims the benefit of priority to Korean Patent Application No. 10-2021-0085994 filed on Jun. 30, 2021 with the Korean Intellectual Property Office (KIPO), the entire content of which is incorporated herein by reference.

### TECHNICAL FIELD

The present disclosure relates to a video surveillance system and, more particularly, to a method and apparatus for detecting an abnormal event in real-time based on an acquired video.

### BACKGROUND

With the exponential increase in the number and scale of video surveillance systems, the time and costs required to detect an abnormal situation in a monitoring target area based on monitoring images acquired by surveillance cameras increase also. Programs automatically detecting moving objects in the monitoring images to detect the abnormal situation are widely being used, but human operators may still be needed to verify a detection result against a system malfunction.

The employment of deep learning in the detection programs is increasing to improve a detection accuracy of the surveillance system. However, the video surveillance system employing the deep learning may reveal a low detection speed, which may be an obstacle to rapidly respond to a dangerous situation such as a robbery, violence, or murder that may happen in the monitoring target area.

### SUMMARY

Provided are a method and apparatus capable of detecting an abnormal event from a monitoring image accurately and speedily in a video surveillance system.

According to an aspect of an exemplary embodiment, a method of detecting an abnormal event in a series of temporally successive images includes: generating a predicted current frame based on a previous frame temporally ahead of an actual current frame and a subsequent frame temporally behind the actual current frame; calculating an anomaly score indicating a difference between the predicted current frame and the actual current frame; and determining that an abnormality is included in the actual current frame when the anomaly score satisfies a predetermined condition.

The previous frame may be temporally ahead of the actual current frame by a plurality of frames, and the subsequent frame may be temporally behind the actual current frame by the plurality of frames.

The predicted current frame may be generated by an artificial neural network comprising a first subnetwork receiving the previous frame as an input and a second subnetwork receiving the subsequent frame as an input. Each of the first and second subnetworks may include at least one layer stage, and each of the layer stage may have at least one convolutional layer.

The operation of generating the predicted current frame may include: receiving, in a layer stage of the first subnetwork, a second feature map from a corresponding layer stage of the second subnetwork to concatenate the second feature map with a first feature map generated by the layer stage of the first subnetwork; and receiving, in the corresponding layer stage of the second subnetwork, the first feature map from the layer stage of the first subnetwork to concatenate the first feature map with the second feature map generated by the corresponding layer stage of the second subnetwork.

The artificial neural network may be used after being trained in advance to generate the predicted current frame based on the previous frame and the subsequent frame in a normal situation where the actual current frame contains no abnormality.

The operation of calculating the anomaly score may include: calculating a plurality of local anomaly scores by moving a window with respect to the actual current frame horizontally and vertically in a unit of a predetermined stride and performing a predetermined operation on pixel value differences between pixels in the predicted current frame and corresponding pixels in the actual current frame for an image frame portion overlapping the window at each window location; and determining the anomaly score by averaging or summing the plurality of local anomaly scores calculated according to a movement of the window.

Each of the plurality of local anomaly scores may be calculated by averaging or summing the pixel value differences between pixels in the predicted current frame and corresponding pixels in the actual current frame for the image frame portion overlapping the window.

The operation of determining the anomaly score may include determining the anomaly score by averaging only a predetermined number of local anomaly scores selected in an order of magnitude among the plurality of local anomaly scores calculated according to the movement of the window.

A size of the window may be set to decrease as the window moves upward with respect to the actual current frame.

The method may further include preprocessing of the series of temporally successive images to convert to black-and-white images or adjust resolutions of the images before generating the predicted current frame.

According to another aspect of an exemplary embodiment, an apparatus for detecting an abnormal situation in a series of temporally successive images includes a processor and a memory storing program instructions to be executed by the processor. The program instructions, when executed by the processor, causes the processor to: generate a predicted current frame based on a previous frame temporally ahead of an actual current frame and a subsequent frame temporally behind the actual current frame; calculate an anomaly score indicating a difference between the predicted current frame and the actual current frame; and determine that an abnormality is included in the actual current frame when the anomaly score satisfies a predetermined condition.

The program instructions causing the processor to generate the predicted current frame may include instructions to: configure an artificial neural network comprising a first subnetwork receiving the previous frame as an input and a second subnetwork receiving the subsequent frame as an input; and generate the predicted current frame by the artificial neural network. Each of the first and second subnetworks may include at least one layer stage, each layer stage having at least one convolutional layer.

The program instructions causing the processor to configure the artificial neural network may include instructions to: receive, in a layer stage of the first subnetwork, a second feature map from a corresponding layer stage of the second subnetwork and concatenate the second feature map with a first feature map generated by the layer stage of the first subnetwork; and receive, in the corresponding layer stage of the second subnetwork, the first feature map from the layer stage of the first subnetwork and concatenate the first feature map with the second feature map generated by the corresponding layer stage of the second subnetwork.

An exemplary embodiment of the present disclosure enables to detect an abnormal event from the monitoring image accurately and speedily in the video surveillance system. Evaluations of the detection performance carried out using datasets used in many studies showed that the detection method according to an exemplary embodiment of the present disclosure achieves detecting the abnormality in real-time with a high detection accuracy.

In particular, the current frame in a situation where the actual current frame is assumed to contain no abnormality can be predicted using an artificial neural network having subnetworks combined with each other, and the abnormal event may be detected very precisely by comparing the predicted current frame and the actual current frame.

In calculating the anomaly score while moving the window, a cascade sliding window method, which reduces the size of the window as the window moves upward, enables to take a perspective of each object into account in the comparison of the predicted current frame and the actual current frame without increasing the computational burden, which facilitates the precise and speedy detection with little error.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic block diagram of a video surveillance system according to an exemplary embodiment of the present disclosure;

FIG. 2 is a flowchart illustrating an abnormality detecting process according to an exemplary embodiment of the present disclosure;

FIG. 3 illustrates an architecture of an artificial neural network shown in FIG. 2 in detail;

FIG. 4 is a flowchart illustrating a process of deriving an anomaly score for a current frame based on a squared error image;

FIG. 5 shows pseudo-codes of an algorithm for implementing the process of deriving the anomaly score shown in FIG. 4;

FIG. 6 illustrates a sliding and resizing of a window;

FIG. 7 is a block diagram of an abnormality detecting apparatus according to an exemplary embodiment of the present disclosure;

FIG. 8 is a table summarizing the AUC values for each dataset according to the window decrease step;

FIG. 9 is a table summarizing frame-level AUCs of the abnormality detecting method according to an exemplary embodiment of the present disclosure and other latest detection methods;

FIG. 10 shows a processing speed per frame according to an exemplary embodiment of the present disclosure for each dataset;

FIG. 11 is a table summarizing the processing speed per frame of the abnormality detecting method according to an exemplary embodiment of the present disclosure and another method;

FIGS. 12A-12C show examples of actual frames, predicted frames, and visualizations of squared errors of the actual frames and respective predicted frames for image frames containing abnormal situations; and

FIG. 13 shows the results of an ablation study.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanying drawings. However, it should be understood that the present disclosure is not limited to particular embodiments and includes all modifications, equivalents, and alternatives falling within the idea and scope of the present disclosure.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” includes any and all combinations of one or more associated items.

When a component is referred to as being “connected” or “coupled” to another component, it means that the component is connected or may be connected logically or physically to the other component. In other words, it is to be understood that the component may be connected or coupled to the other component indirectly through an object therebetween instead of being directly connected or coupled to the other component.

The terminologies are used herein for the purpose of describing particular embodiments only and are not intended to limit the disclosure. The singular forms include plural referents unless the context clearly dictates otherwise. Also, the expressions “˜ comprises,” “˜ includes,” “˜ constructed,” “˜ configured” are used to refer to a presence of a combination of enumerated features, numbers, processing steps, operations, elements, or components, but are not intended to exclude a possibility of a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with meanings in the context of related technologies and should not be interpreted as having ideal or excessively formal meanings unless explicitly defined in the present application.

Hereinafter, embodiments of the present disclosure will be described in more detail with reference to the accompanying drawings. In describing the present disclosure, in order to facilitate an overall understanding thereof, the same components are designated by the same reference numerals in the drawings and are not redundantly described here. Also, detailed descriptions of well-known functions or configurations that may obscure the subject matter of the present disclosure will be omitted for simplicity.

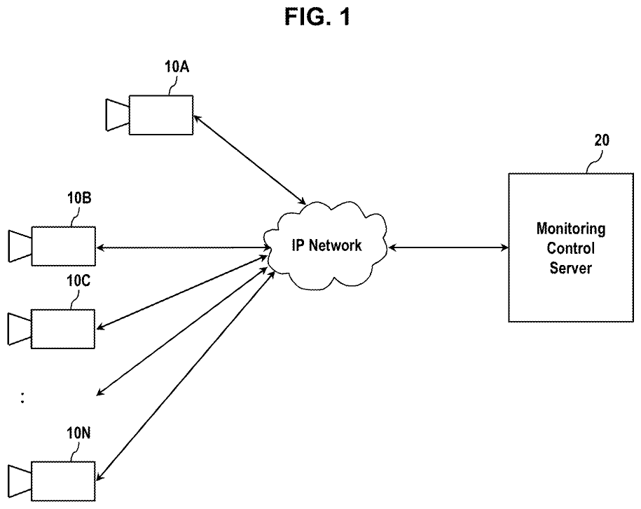

FIG. 1 is a schematic block diagram showing an overall configuration of a video surveillance system according to an exemplary embodiment of the present disclosure. The video surveillance system includes a plurality of surveillance cameras 10A-10N distributed in a monitoring target area to acquire a monitoring image for a part of the monitoring target area and a monitoring control server 20 accessible by the plurality of surveillance cameras 10A-10N. In an exemplary embodiment, each of the plurality of surveillance cameras 10A-10N can be connected to the monitoring control server 20 through an IP network based on a wired network and/or a wireless network.

Each of the cameras 10A-10N acquires the monitoring image of its surrounding area with an appropriate zoom ratio while panning and tilting in response to a control signal from the monitoring control server 20. The monitoring control server 20 may detect a moving object or detect an abnormal event contained in the monitoring images from the monitoring cameras 10A-10N, and control panning, tilting, and zooming of the monitoring cameras 10A-10N as necessary. In addition, the monitoring control server 20 may generate an alarm when an abnormal event is detected in the images acquired by the monitoring cameras 10A-10N. In this specification including the appended claims, the term “abnormality” or “abnormal event” refers to a dangerous situation such as a robbery, violence, or murder, but the types of the abnormality are not limited thereto.

The monitoring control server 20 performs operations required for processing the image data, detecting moving objects, detecting of abnormal events, displaying images, and generating the alarm, and may include at least one processor such as a graphic processor unit (GPU) as described below. The monitoring control server may serve as an abnormality detecting apparatus that performs abnormality detecting operations through executions of program instructions by at least one processor. Alternatively, however, the operations such as the processing the image data, the detecting the moving objects, and detecting the abnormal events may be performed by each of the monitoring cameras 10A-10N rather than the monitoring control server 20, and an operation result may be transmitted to the monitoring control server 20 by the monitoring camera.

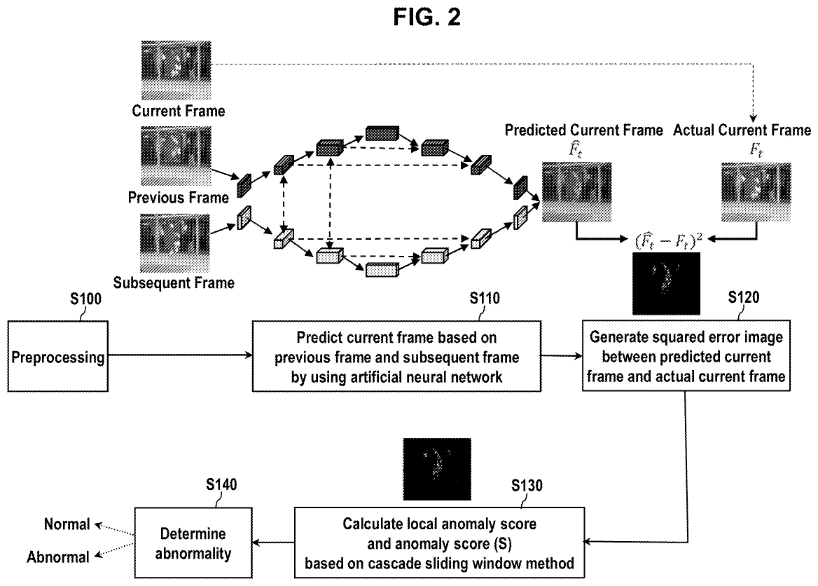

FIG. 2 is a flowchart illustrating an abnormality detecting process according to an exemplary embodiment of the present disclosure. The abnormality detecting process according to the present embodiment may include preprocessing of an image (S100), predicting a current frame by an artificial neural network (S110), calculating a difference image between a predicted current frame and an actual current frame (S120), calculating an anomaly score based on a pixel value distribution in the difference image (S130), and determining whether an abnormality has occurred in the current frame based on the anomaly score (S140).

In the operation S100 of preprocessing the image, an input color image is converted into a black-and-white image. In addition, the size of the input image may be changed to a certain size, e.g. 256×256×1, where ‘256×256’ indicates resolutions in horizontal and vertical directions, and ‘1’ represents a number of channels. An image frame on which the preprocessing has been completed may be stored in a frame memory (not shown). In an exemplary embodiment, the frame memory may store at least five frames from at least a second previous frame Fₜ₋₂ to a second subsequent frame Fₜ₊₂ with respect to the current frame Fₜ.

In the operation S110 of predicting the current frame by the artificial neural network, images of a previous frame and a subsequent frame of the current frame are received as inputs, and the predicted current frame is generated by a Cross U-Net artificial neural network according to the present disclosure. In an exemplary embodiment, the images used as inputs in the artificial neural network are the second previous frame Fₜ₋₂ and the second subsequent frame Fₜ₊₂ of the current frame Fₜ. The artificial neural network generates the predicted current frame \hat{F}ₜ based on these image frames.

Before being applied to a real abnormality detection operation, the artificial neural network may be trained to accurately predict the current frame from the previous and subsequent frames in a normal situation. Accordingly, the trained artificial neural network can predict the current frame better in a normal situation than in an abnormal event, and there is little difference between the predicted current frame and the actual current frame. The present disclosure uses this difference to detect the abnormal event. That is, when there is a difference larger than a certain degree between the predicted current frame determined and the actual current frame, the abnormality detecting apparatus determines that an abnormality has occurred in the current frame.

In the operation 120, the difference image between the predicted current frame \hat{F}ₜ and the actual current frame Fₜ is calculated. The word “difference image” is used herein to refer to an array of numbers generated by subtracting pixel values of two image frames in pixel-by-pixel. The difference image may be displayed on the screen to be visually recognized as shown in FIG. 2, but the present disclosure is not limited thereto and the difference image may be stored into a frame memory or a conventional storage device such as RAM to be used for subsequent calculations. Meanwhile, each pixel value in the “difference image” may be an absolute value or a squared value of the difference in the pixel values of corresponding pixels of the two image frames rather than a simple difference in the pixel values. In the exemplary embodiment detailed below, the “difference image” is a square error image in which the pixel value of each pixel is the square of the difference in the pixel values of the corresponding pixels of the two image frames \hat{F}ₜ and Fₜ. Hereinbelow, squared error image may be denoted by a symbol of (\hat{F}ₜ−Fₜ)².

In the operation 130, the anomaly score which is an index indicating a possibility that an abnormal event is included in the current frame is calculated based on the pixel value distribution in the difference image. In an exemplary embodiment, in order to obtain the anomaly score, a local anomaly score can be calculated by sliding a window having a certain size to move relatively with respect to the image frame, i.e., the current frame or the squared error image, in a unit of a certain stride horizontally and vertically. The local anomaly score may be calculated as an average of the squared errors for the pixels in an image frame portion overlapping the window for each sliding step. Afterwards, an average value of at least some of all the local anomaly scores calculated over the entire region of the image frame may be determined as the anomaly score (S) for the entire image frame. In case that the anomaly score (S) is determined using only some of the local anomaly scores, the anomaly score (S) may be determined by selecting a certain number of the largest local anomaly scores and averaging the selected anomaly scores.

If the anomaly score S is determined in this way, it can be said that the larger the anomaly score S is, the higher the probability of including the abnormal event in the current frame is. Accordingly, in operation 140, it may be determined that an abnormality has occurred in the current frame when the anomaly score S is greater than a certain threshold.

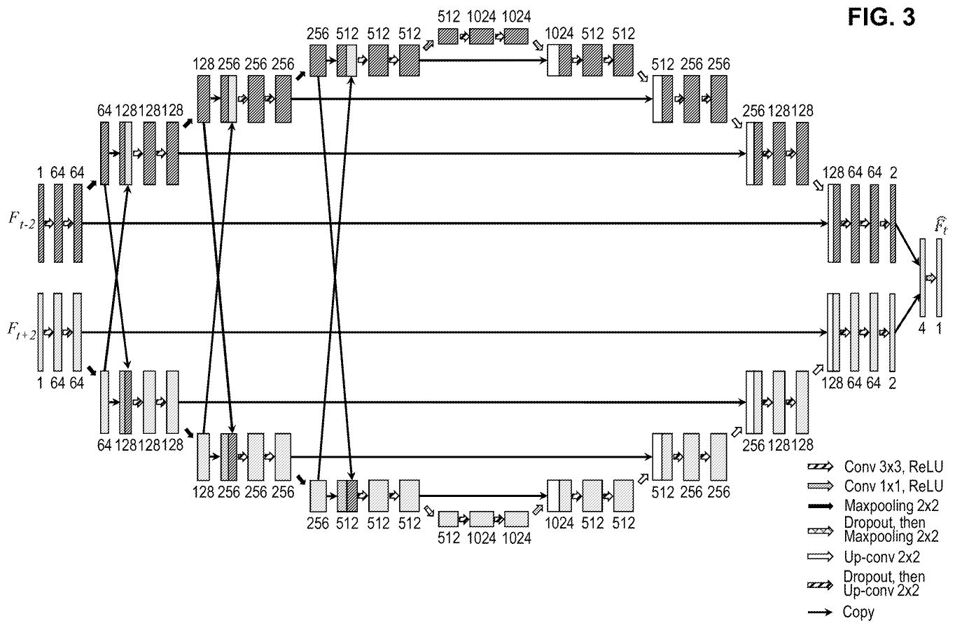

FIG. 3 illustrates an architecture of the artificial neural network shown in FIG. 2 in detail.

The Cross U-Net artificial neural network shown in the drawing, which is an artificial neural network model newly proposed by the present disclosure, includes two sub-networks based on U-Net. A first subnetwork located in the upper portion of the drawing receives the second previous frame Fₜ₋₂ of the current frame Fₜ as the input, and the second subnetwork located in the lower portion of the drawing receives the second subsequent frame Fₜ₊₂ of the current frame Fₜ as the input. The artificial neural network generates the predicted current frame from the second previous frame Fₜ₋₂ and the second subsequent frame Fₜ₊₂. As mentioned above, the second previous frame Fₜ₋₂ and the second subsequent frame Fₜ₊₂ may be image frames having undergone the preprocessing operation to be converted into the black-and-white image and changed to the size of 256×256×1. However, the present disclosure is not limited thereto.

Each subnetwork includes a contracting path and an expansive path, which may be arranged symmetrically to make the subnetwork seem to have a U-shaped architecture. The contracting path includes repetitive applications of two 3×3 convolutions, a 2×2 max-pooling operation for downsampling feature maps, and a concatenation with feature maps copied and cropped from the other subnetwork. A number of feature channels is doubled in each stage in the contracting path. The expansive path includes repetitive applications of a 2×2 up-convolution for upsampling the feature maps, a concatenation with feature maps copied and cropped from a corresponding stage in the contracting path, and two 3×3 convolutions. The number of feature channels is halved in each stage in the expansive path.

Specifically, in the embodiment of FIG. 3, the Cross U-Net artificial neural network may generate the predicted current frame \hat{F}ₜ through a first through tenth stages. Among the first through tenth stages, the first through fifth stages may be on the contracting path, and the fifth through ninth stages may be on the expansive path.

In the first stage, two convolutional layers in the first subnetwork indicated by arrows receive the second previous frame Fₜ₋₂ and perform convolutions using kernels having a size of 3×3. Feature maps generated by the convolutions are downsampled by a 2×2 maxpooling in a pooling layer. In the first subnetwork, feature maps of 64 channels are transferred from the first stage to the second stage. Similarly, two convolutional layers in the first stage of the second subnetwork receive the second subsequent frame Fₜ₊₂ and perform convolutions using kernels having a size of 3×3. Feature maps generated by the convolutions are downsampled by a 2×2 maxpooling in a pooling layer. Feature maps of 64 channels are transferred from the first stage to the second stage in the second subnetwork also.

All or part of the feature maps of 64 channels transferred from the first stage to the second stage in the first subnetwork are copied and cropped and provided to the second subnetwork. Also, all or part of the feature maps of 64 channels transferred from the first stage to the second stage in the second subnetwork are copied and cropped and provided to the first subnetwork. The feature maps provided to the first subnetwork by the second subnetwork are concatenated to the feature maps of the first subnetwork. Two convolutional layers in the second stage of the first subnetwork receive the concatenated feature maps and perform convolutions using 3×3 kernels. The feature maps generated by the convolutions are downsampled by a 2×2 maxpooling in a pooling layer. Feature maps of 128 channels are transferred from the second stage to the third stage in the first subnetwork. Similarly, the feature maps provided to the second subnetwork by the first subnetwork are concatenated to the feature maps of the second subnetwork. Convolutional layers in the second stage of the second subnetwork receive the concatenated feature maps and perform convolutions using 3×3 kernels. The feature maps generated by the convolutions are downsampled by a 2×2 maxpooling in a pooling layer. Feature maps of 128 channels are transferred from the second stage to the third stage in the second subnetwork.

The third and fourth stages of the first and second subnetworks operate similarly to the second stages. In the first and second subnetworks, feature maps of 256 channels are transferred from the third stage to the fourth stage, and feature maps of 512 channels are transferred from the fourth stage to the fifth stage. Before the feature maps generated by the convolutions in the fourth stage of the first and second subnetworks are downsampled by the 2×2 maxpooling in the pooling layer, a dropout may be applied to the feature maps.

Convolutional layers in the fifth stage of the first subnetwork perform convolutions on feature maps received from the fourth stage using 3×3 kernels to generate feature maps of 1024 channels. The fifth stage of the first subnetwork may include an up-convolution layer, which performs an up-convolution including a 2×2 upsampling and 2×2 convolutions on the feature maps. The 2×2 upsampling doubles the dimension of the feature maps and the 2×2 convolutions reduce the number of channels by a half. As a result, the 1024-channel feature maps generated by the convolutions may be converted into 512-channel feature maps having doubled dimensions and applied to the sixth stage. Similarly, in the second subnetwork, convolutional layers in the fifth stage perform convolutions on the feature maps received from the fourth stage using 3×3 kernels to generate feature maps of 1024 channels. The fifth stage of the second subnetwork may include an up-convolution layer, which performs the up-convolution including the 2×2 upsampling and the 2×2 convolutions on the feature maps. The 2×2 upsampling doubles the dimension of the feature maps and the 2×2 convolutions reduce the number of channels by a half. As a result, the 1024-channel feature maps generated by the convolutions may be converted into 512-channel feature maps having doubled dimensions and applied to the sixth stage. In the fifth stage of the first and second subnetworks, before the feature maps go through the up-convolution, the dropout may be applied to the feature maps.

Meanwhile, the feature maps generated by convolutions in the fourth stage of the first subnetwork are copied and cropped and provided to the sixth stage. The path of this feature map is indicated by a skip connection. In addition, the skip connections are also formed between the third stage and the seventh stage, between the second stage and the eighth stage, and between the first stage and the ninth stage. That is, the feature maps generated by convolutions in the third stage are copied and cropped and provided to the seventh stage, the feature maps generated by convolutions in the second stage are copied and cropped and provided to the eighth stage, and the feature maps generated by the convolutions in the first stage are copied and cropped and provided to the ninth stage. The skip connections are similarly formed in the second subnetwork.

In the sixth stage of the first subnetwork, the 512-channel feature maps received from the up-convolution layer of the fifth stage are concatenated with the 512-channel feature maps transferred from the fourth stage to form feature maps of 1024 channels. Convolutional layers perform convolutions on the concatenated feature maps using 3×3 kernels to generate feature maps of 512 channels. The sixth stage of the first subnetwork may include an up-convolution layer, which performs the up-convolution including the 2×2 upsampling and the 2×2 convolutions on the 512-channel feature maps. The 2×2 upsampling doubles the dimension of the feature maps and the 2×2 convolutions reduce the number of channels by a half. As a result, the 512-channel feature maps generated by the convolutions may be converted into 256-channel feature maps having doubled dimensions and applied to the seventh stage. Similarly, in the sixth stage of the second subnetwork, the 512-channel feature maps received from the up-convolution layer of the fifth stage are concatenated with the 512-channel feature maps transferred from the fourth stage to form feature maps of 1024 channels. Convolutional layers perform convolutions on the concatenated feature maps using 3×3 kernels to generate feature maps of 512 channels. The sixth stage of the second subnetwork may include an up-convolution layer, which performs the up-convolution including the 2×2 upsampling and the 2×2 convolutions on the 512-channel feature maps. The 2×2 upsampling doubles the dimension of the feature maps and the 2×2 convolutions reduce the number of channels by a half. As a result, the 512-channel feature maps generated by the convolutions may be converted into 256-channel feature maps having doubled dimensions and applied to the seventh stage.

The seventh to ninth stages of the first and second subnetworks operate similarly to the sixth stages. In each of the first and second subnetworks, the seventh stage concatenates the 256-channel feature maps from the sixth stage with another 256-channel feature maps copied from the third stage and performs the 3×3 convolutions and the up-convolution to output 128-channel feature maps. The eighth stage concatenates the 128-channel feature maps from the seventh stage with another 128-channel feature maps copied from the second stage and performs the 3×3 convolutions and the up-convolution to output 64-channel feature maps. The ninth stage concatenates the 64-channel feature maps from the eighth stage with another 64-channel feature maps copied from the first stage and performs the 3×3 convolutions to output feature maps of 2 channels.

A final stage includes a concatenation layer and a convolutional layer. The concatenation layer receives the feature maps of 2 channels from each of the ninth stages of the first and second subnetworks and concatenates the feature maps of 4 channels to output concatenated feature maps of 4 channels. The convolutional layer performs point-wise convolutions on the concatenated feature maps of 4 channels using a 1×1 kernel to output a convolution result as the predicted current frame \hat{F}ₜ.

As described above, according to an exemplary embodiment of the present disclosure, the predicted current frame \hat{F}ₜ is generated by combining the first subnetwork processing the second previous frame Fₜ₋₂ and the second subnetwork processing the second subsequent frame Fₜ₊₂. Further, connections are established between the corresponding stages of the first and second subnetworks so as to allow exchanges and concatenations of the feature maps in the corresponding stages. Such a combination of the subnetworks enables to predict the current frame more precisely in the absence of an anomaly.

In the neural network model described above, all the convolutional layers may use the Rectified Linear Unit (ReLU) as an activation function. Also, a pixel-wise mean squared error expressed by Equation 1 may be used as a loss function.

$$L ( \hat{F} , F ) = \frac{1}{h \cdot w} {\sum }_{i = 1}^{h} {\sum }_{j = 1}^{w} {( {\hat{F}}_{ij} - {F}_{ij} )}^{2} \qquad [ Equation 1 ]$$

Here, ‘w’ denotes a horizontal dimension of the frame, i.e., a horizontal resolution, and ‘h’ denotes a vertical dimension of the frame, i.e., a vertical resolution. ‘Fᵢⱼ’ denotes a pixel value of a pixel at a position (i,j) in the actual current frame, and ‘\hat{F}ᵢⱼ’ denotes a pixel value of the pixel at the position (i,j) in the predicted current frame. The value (\hat{F}ᵢⱼ−Fᵢⱼ)² may be obtained as a squared error for the pixel in a squared error image used and need not be calculated separately.

The neural network may be trained to accurately predict the current frame \hat{F}ₜ from the second previous frame Fₜ₋₂ and the second subsequent frame Fₜ₊₂ in a normal condition other than an abnormal situation before the network is actually applied to an abnormality detection as mentioned above, and the training result is reflected in the filters, i.e., the kernels, used for the convolutional operations. Accordingly, the trained neural network can predict the current frame quite well, so that there is little significant difference between the predicted current frame \hat{F}ₜ and the actual current frame Fₜ except the abnormality. The method and apparatus according to the present disclosure detects the abnormal events based on this feature. That is, the abnormality detecting apparatus according to an exemplary embodiment of the present disclosure may determine that an abnormal event has occurred in the current frame Fₜ when there is a difference greater than a certain degree between the predicted current frame \hat{F}ₜ determined by the neural network and the actual current frame Fₜ.

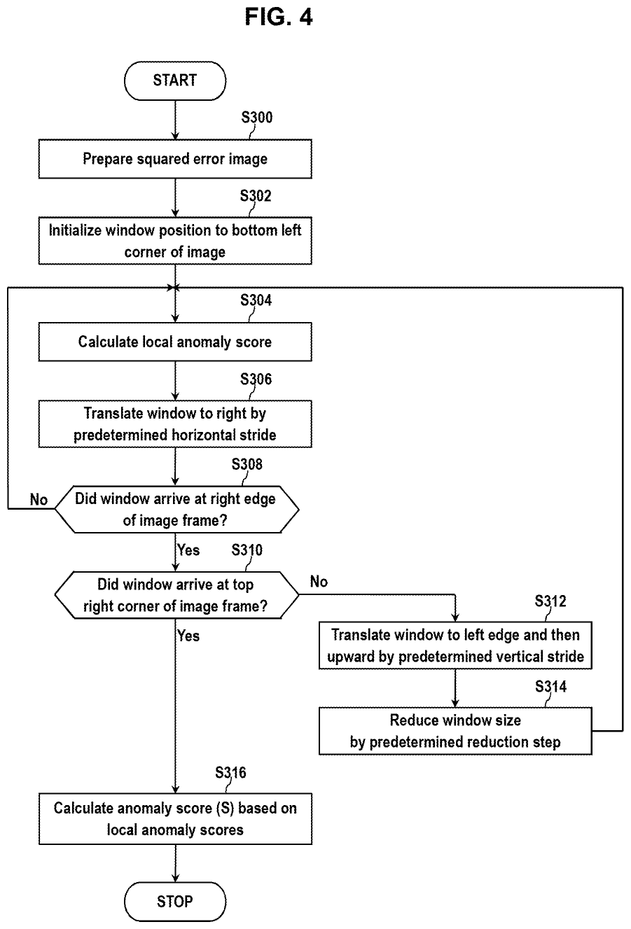

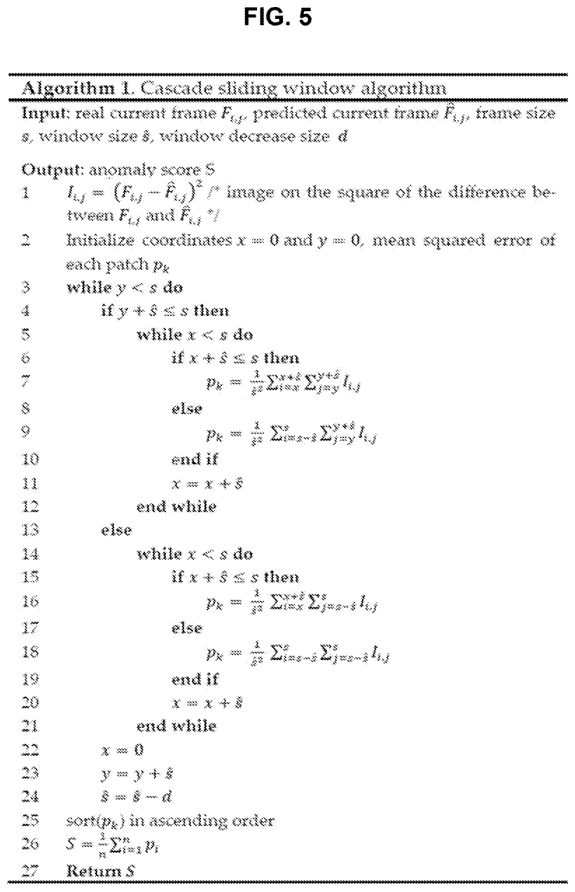

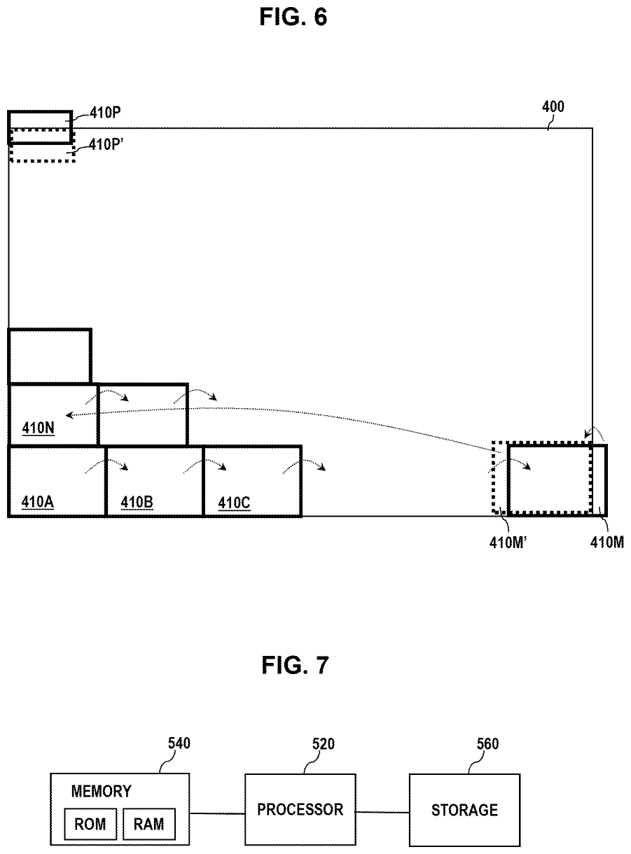

FIG. 4 is a flowchart illustrating a process of deriving the anomaly score for the current frame based on the squared error image, and FIG. 5 shows pseudo-codes of an algorithm for implementing the process of deriving the anomaly score shown in FIG. 4. FIG. 6 illustrates a sliding and resizing of a window.

As mentioned above, a local anomaly score may be calculated while moving a window in a unit of a certain stride horizontally and vertically with respect to the image frame. The local anomaly score may be calculated as an average of squared errors for pixels in an image frame portion overlapping the window. Then, an average of at least some of the local anomaly scores calculated over the entire region of the image frame may be determined as the anomaly score for the entire image frame.

First, the abnormality detecting apparatus may determine whether a squared error image is prepared, that is, if the squared error Iᵢⱼ=(\hat{F}ᵢⱼ−Fᵢⱼ)² that is a squared value of a difference between the pixel values of the predicted current frame \hat{F}ₜ and the actual current frame Fₜ is calculated or not for all the pixels of the image frame (operation 300). If the squared error image is not prepared, the abnormality detecting apparatus may prepare the square error image. Alternatively, however, the operation 300 may be performed later than an operation 302 or another operation. Further, the operation 300 of preparing the squared error image may be omitted, and the squared error may be calculated whenever necessary after the operation 302, i.e., during process of deriving the anomaly score shown in FIG. 4.

Subsequently, the coordinates of a bottom left corner of the window are initialized to (0, 0). Accordingly, the window will be positioned at the bottom left corner in the squared error image (operation 302).

In operation 304, the abnormality detecting apparatus obtains the local anomaly score pₖ by calculating the average of the squared errors for the pixels in the region overlapping the window, as expressed by Equation 2. That is, the local anomaly score pₖ may be the average of pixel values in the squared error image patch corresponding to the window.

$${p}_{k} = {\sum }_{i = x}^{x + \hat{s}} {\sum }_{j = y}^{y + \hat{s}} {I}_{i , j} \qquad [ Equation 2 ]$$

In Equation 2 and FIG. 5, ‘s’ denotes a width and height of the image frame and ‘ŝ’ denotes a width and height of the window. It is assumed that the width and the height of the image frame are the same as each other and the width and the height of the window are the same as each other. However, the present disclosure is not limited thereto, and the width and the height of the image frame may be different from each other and the width and the height of the window may be different from each other.

Next, the window is translated to the right by a certain horizontal stride (operation 306). The horizontal stride may have the same size as the width of the window. After the window is translated, the local anomaly score pₖ is calculated for the translated window. The translation of the window and the calculation of the local anomaly score may continue until the window reaches a right edge of the image frame.

When the window reaches the right edge of the image frame (operation 308) but the window does not reach a top right corner of the image frame (operation 310), the window is translated to the left edge again and translated upward by a certain vertical stride (operation 312). The vertical stride may have the same size as the height of the window. After the window is translated upward vertically, the size of the window may be reduced by a certain reduction size (operation 314). The reduction of the window size may be accomplished only with respect to the height. Alternatively, however, the reduction of the window size may be accomplished with respect to the width in addition to the height. The reduction of the window size takes into account a phenomenon that a size of an object decreases as the object moves away from the camera, i.e., as the object moves toward an upper side of the image frame, due to a perspective difference of the objects in the image frame. Accordingly, the window gets smaller gradually as it is translated upward in the image frame in accordance with an exemplary embodiment of the present disclosure. Considering that the window size becomes smaller as it is translated upward, a technique of calculating the anomaly score while moving the window as shown in FIGS. 4 and 5 may be referred to as a ‘cascade sliding window’ method.

After the window is translated in the operation 312, the calculation of the local anomaly score pₖ for the moved window and an additional translation of the window may be continued (operations 304 and 306). The process of calculating the local anomaly score pₖ while moving the window to the right and upward in the operations 304-314 may continue until the window reaches the top right corner of the image frame.

After it is determined that the window reached the top right corner of the image frame (operation 310), the average of at least some of the local anomaly scores pₖ among the local anomaly scores pₖ calculated for all the window positions may be calculated by Equation 3 and determined as an anomaly score S for the image frame (operation 316). Though an average of all the local anomaly scores pₖ may be determined as the anomaly score S for the image frame, an average of only some of the local anomaly scores pₖ may be determined as the anomaly score S for the image frame. For example, after sorting all local anomaly scores pₖ in an ascending or descending order, only a certain number of local anomaly scores pₖ may be averaged to determine the anomaly score S. A higher anomaly score may indicate a higher probability that the current frame contains an abnormal event.

$$S = \frac{1}{n} {\sum }_{i = 1}^{n} {p}_{i} \qquad [ Equation 3 ]$$

When moving the window to the right by the horizontal stride in the operation 306, a space for moving the window to the right may be insufficient and an x-coordinate of a rightmost column of a next window 410M may become larger than an x-coordinate of a rightmost column of the image frame 400. In such a case, a window position 410M′ of the next window may be determined such the rightmost column of the next window coincides with the rightmost column of the image frame 400, and then the local anomaly score pₖ may be calculated for the adjusted window position (See steps 8-10 of FIG. 5, and FIG. 6).

Similarly, when moving the window upwards by the vertical stride in the operation 312, a space for moving the window upwards may be insufficient and a y-coordinate of a top row of the next window 410P may become larger than a y-coordinate of a top row of the image frame 400. In such a case, a window position 410P′ of the next window may be determined such the top row of the next window coincides with the top row of the image frame 400, and then the local anomaly score pₖ may be calculated for the adjusted window position (See steps 17-19 of FIG. 5, and FIG. 6).

Although it was assumed above that the width and the height of the image frame are the same as each other and denoted commonly by ‘s’ in the embodiment shown in FIG. 5, the width and the height of the image frame may be different from each other. Also, although it was assumed above that the width and the height of the window are the same as each other and denoted commonly by ‘ŝ’, the width and the height of the window may be different from each other. The window decrease step ‘d’ may also be set differently for the horizontal and vertical directions.

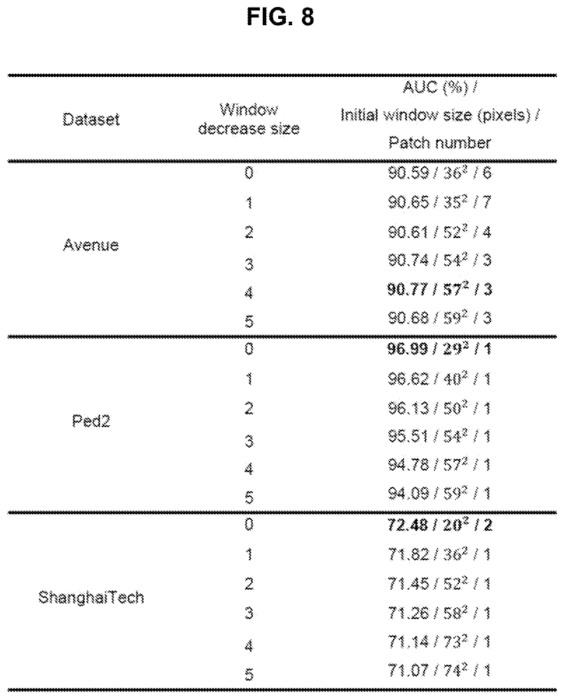

FIG. 7 is a block diagram of an abnormality detecting apparatus according to an exemplary embodiment of the present disclosure. The abnormality detecting apparatus according to the present embodiment may include at least one processor 520, a memory 540, and a storage 560. As mentioned above, the abnormality detecting apparatus may be implemented by the monitoring control server 20 in the video surveillance system shown in FIG. 1. In such a case, the monitoring control server 20 may receive the monitoring image acquired by each of the monitoring cameras 10A-10N and detect abnormal events in the monitoring images received from the monitoring cameras 10A-10N. Alternatively, however, each of the monitoring cameras 10N-10N may serve as the abnormality detecting apparatus instead of the monitoring control server 20 and provide the monitoring control server 20 with a detection result.

The processor 520 may execute program instructions stored in the memory 540 and/or the storage 560. The processor 520 may be at least one central processing unit (CPU), a graphics processing unit (GPU), or another kind of dedicated processor suitable for performing processes according to the present disclosure.

The memory 540 may include, for example, a volatile memory such as a read only memory (ROM) and a nonvolatile memory such as a random access memory (RAM). The memory 540 may load the program instructions stored in the storage 560 to provide to the processor 520 so that the processor 520 may execute the program instructions.

The storage 560 may include an intangible recording medium suitable for storing the program instructions, data files, data structures, and a combination thereof. Any device capable of storing data that may be readable by a computer system may be used for the storage. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The program instructions stored in the storage 560 may include an abnormality detection program for implementing the abnormality detecting method according to the present disclosure. The program instructions, when executed by the processor 520, may cause the processor 520 to: generate a predicted current frame based on a previous frame temporally ahead of an actual current frame and a subsequent frame temporally behind the actual current frame; calculate an anomaly score indicating a difference between the predicted current frame and the actual current frame; and determine that an abnormality is included in the actual current frame when the anomaly score satisfies a predetermined condition. The program instructions may be executed by the processor 520 after being loaded into the memory 540 under a control of the processor 520 to implement the method according to the present invention.

The inventors have tested the accuracy and speed of the abnormality detecting apparatus according to an exemplary embodiment of the present disclosure using CUHK Avenue, UCSD Ped2, and ShanghaiTech Campus datasets, which are commonly used in the research of the image analysis. The characteristics of each dataset are as follows.

The CUHK Avenue dataset contains 16 training videos and 21 test videos with a resolution of 640×360 and a frame rate of 25 frames per second (fps). This dataset has the characteristics that the object gets smaller as the object moves away from the camera.

The UCSD Ped2 dataset contains 16 training videos and 12 test videos with a resolution of 360×240 and the frame rate of 10 fps. This dataset has the characteristics that the size of the object remains almost the same when the object moves away from the camera.

The ShanghaiTech Campus dataset contains 330 training videos and 107 test videos with a resolution of 856×480 and the frame rate of 24 fps. Unlike the CUHK Avenue and UCSD Ped2 datasets, this dataset has the characteristics that the videos have been recorded at 13 locations at various angles and with various light conditions.

The inventors trained the Cross U-Net model which is the artificial neural network according to the present disclosure with the training videos of the datasets and obtained the anomaly scores for each frame of the test video using the trained Cross U-Net model and the cascade sliding window method. The inventors obtained a receiver operating characteristic (ROC) curve based on the anomaly score for each frame and the inclusion of an actual abnormal event, and then obtained a frame-level area under the ROC curve (AUC) using the ROC curve.

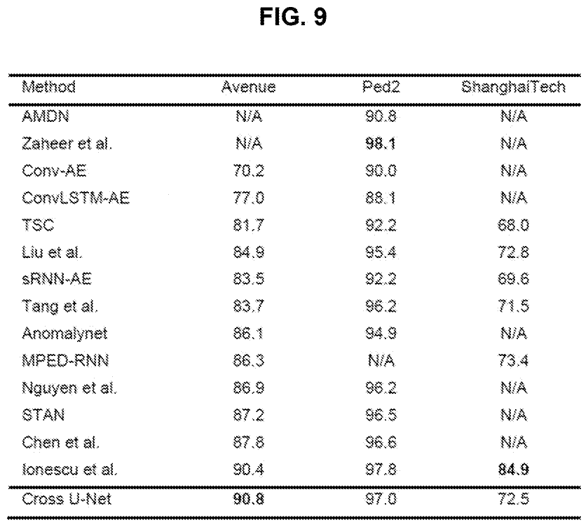

FIG. 8 is a table summarizing the AUC values for each dataset according to the window decrease step. The inventors obtained the AUC values of 90.77% from the Avenue dataset, 96.99% from the UCSD Ped2 dataset, and 72.48% from the ShanghaiTech dataset. In case of the CUHK Avenue dataset, the highest AUC was obtained when the window reduction unit was 4 unlike the other two datasets, which show that the cascade sliding window method is effective for the CUHK Avenue dataset having the characteristics that the object gets smaller as the object moves away from the camera.

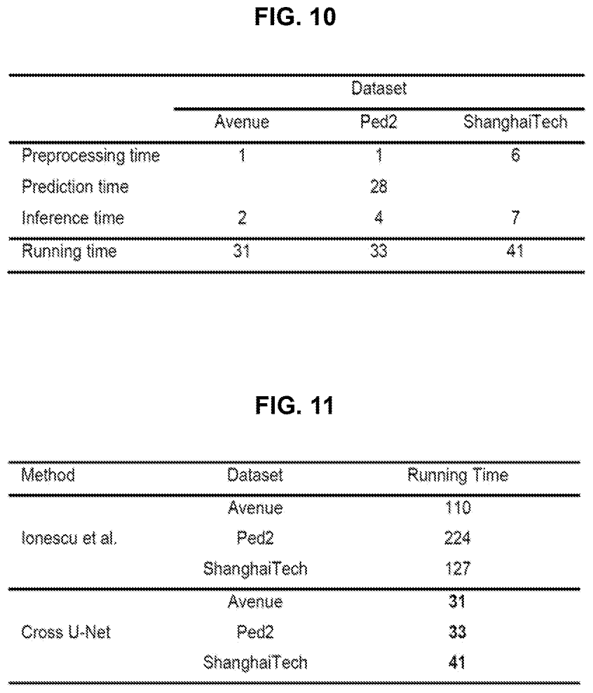

FIG. 9 is a table comparing the frame-level AUC of the abnormality detecting method according to the present disclosure and other latest detection methods for the datasets. It can be seen that the method of the present disclosure achieved the highest AUC for the CUHK Avenue dataset, and achieved relatively high AUCs for the other datasets. The detection methods compared with the method of the present disclosure in the table of FIG. 9 includes:
Appearance and Motion DeepNet (AMDN) disclosed in Xu, D., Yan, Y., Ricci, E., et al., 2017. Detecting anomalous events in videos by learning deep representations of appearance and motion. Comput. Vision Image Understand. 156, 117-127;
a method disclosed in Zaheer, M. Z., A. Mahmood, M. Astrid, et al., 2020a. CLAWS: Clustering assisted weakly supervised learning with normalcy suppression for anomalous event detection. European Conference on Computer Vision, Springer;
Convolution Auto-Encoder (Conv-AE) disclosed in Hasan, M., Choi, J., Neumann, J., et al., 2016. Learning temporal regularity in video sequences. Proceedings of the IEEE Conference on Computer Vision and Pattern Recognition;
Convolutional Long Short Term Memory (ConvLSTM) disclosed in Luo, W., Liu, W., Gao, S., 2017b. Remembering history with convolutional LSTM for anomaly detection. 2017 IEEE International Conference on Multimedia and Expo (ICME). IEEE;
Temporally-coherent sparse coding (TSC) disclosed in Luo, W., Liu, W., Gao, S., 2017a. A revisit of sparse coding based anomaly detection in stacked rnn framework. Proceedings of the IEEE International Conference on Computer Vision;
a method disclosed in Liu, W., Luo, W., Lian, D., et al., 2018. Future frame prediction for anomaly detection—a new baseline. Proceedings of the IEEE Conference on Computer Vision and Pattern Recognition;
Stacked Recurrent Neural Network Autoencoder (sRNN-AE) disclosed in Luo, W., Liu, W., Lian, D., et al., 2019. Video anomaly detection with sparse coding inspired deep neural networks. IEEE Trans. Pattern Anal. Mach. Intell;
a method disclosed in Tang, Y., Zhao, L., Zhang, S., et al., 2020. Integrating prediction and reconstructionfor anomaly detection. Pattern Recogn. Lett. 129, 123-130;
Anomalynet disclosed in Zhou, J. T., Du, J., Zhu, H., et al., 2019a. Anomalynet: An anomaly detection network for video surveillance. IEEE Trans. Inf. Forensics Secur. 14 (10), 2537-2550;
Message-Passing Encoder-Decoder Recurrent Neural Network (MPED-RNN) disclosed in Morais, R., Le, V., Tran, T., et al., 2019. Learning regularity in skeleton trajectories for anomaly detection in videos. Proceedings of the IEEE/CVF Conference on Computer Vision and Pattern Recognition;
Nguyen, T.-N., Meunier, J., 2019. Anomaly detection in video sequence with appearance-motion correspondence. Proceedings of the IEEE/CVF International Conference on Computer Vision;
Spatio-temporal adversarial network (STAN) disclosed in Lee, S., Kim, H. G., Ro, Y. M., 2018. STAN: Spatio-temporal adversarial networks for abnormal event detection. IEEE international Conference on Acoustics, Speech and Signal Processing (ICASSP);
a method disclosed in Chen, D., Wang, P., Yue, L., Zhang, Y., Jia, T., 2020. Anomaly detection in surveillance video based on bidirectional prediction. Image and Vision Computing. 98, 103915; and
a method disclosed in Ionescu, R. T., Khan, F. S., Georgescu, M.-I., et al., 2019. Object-centric auto-encoders and dummy anomalies for abnormal event detection in video. Proceedings of the IEEE/CVF Conference on Computer Vision and Pattern Recognition.

In order to measure the speed of detecting the abnormal events which is one of the most important factors in the video surveillance system, the processing time per frame was measured by dividing into a preprocessing time, a current frame prediction time, and an abnormal event inference time. The ‘preprocessing time’ includes a time to extract frames from the video and convert the frames into images before inputting the frames to the Cross U-Net model, a time to convert color images to black-and-white images, and a time to convert the size of the images to a prescribed size, e.g., 256×256. The ‘current frame prediction time’ refers to a time required by the Cross U-Net model to predict the current frame using the previous frame and the subsequent frame. The ‘abnormal event inference time’ refers to a time to infer the anomaly score of the current frame using the cascade sliding window method.

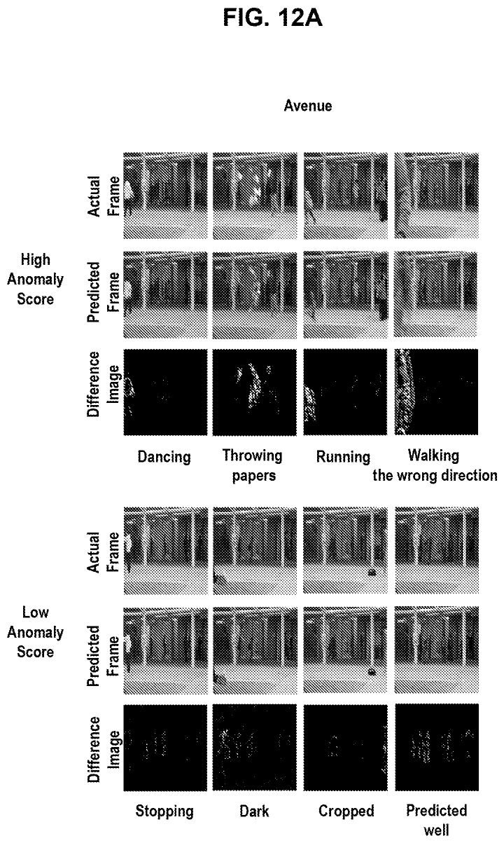

FIG. 10 shows a processing speed per frame according to an exemplary embodiment of the present disclosure for each dataset, measured in an environment of INTEL Core i9-10940X CPU operating at 3.30 GHz and equipped with NVIDIA TITAN RTX and GDDR6 of 24 GB. FIG. 10 shows that the abnormality detecting method according to an exemplary embodiment of the present disclosure revealed a processing time of 31 milliseconds (ms) per each frame (i.e., processing speed of about 32 fps) for the CUHK Avenue dataset, 33 ms (i.e., about 30 fps) for the UCSD Ped2 dataset, and 41 ms (i.e., about 24 fps) for the ShanghaiTech Campus dataset. This means that the abnormality detecting method according to an exemplary embodiment is capable of detecting an abnormal event in real-time in a video in the CUHK Avenue dataset with the frame rate of 25 fps, in a video in the UCSD Ped2 dataset with the frame rate of 10 fps, and in the video in the ShanghaiTech dataset with the frame rate of 24 fps.

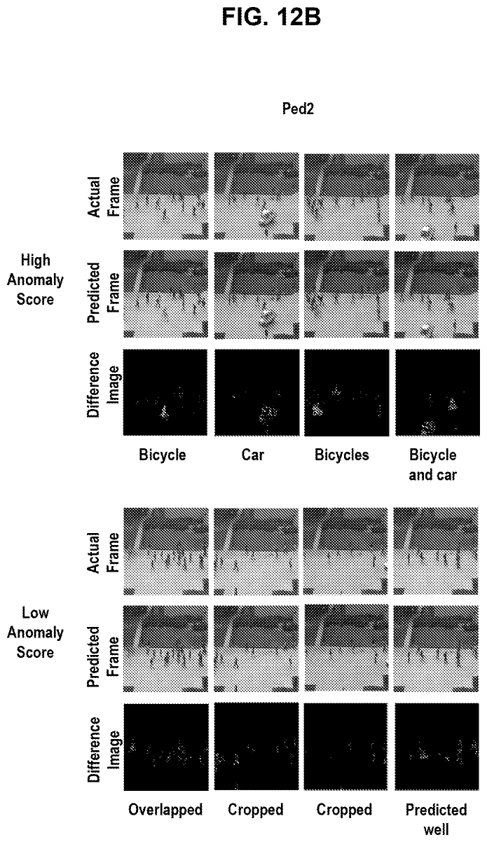

Comparing the processing speed for each frame with the method of Ionescu et al. which has shown the higher frame-level AUC for the UCSD Ped2 dataset and the ShanghaiTech Campus dataset than the method of the present disclosure, the abnormality detecting method according to an exemplary embodiment is 4 times faster in case of the CUHK Avenue dataset, 7 times faster in case of the UCSD Ped2 dataset, and 3 times faster in case of the ShanghaiTech Campus dataset as shown in FIG. 11.

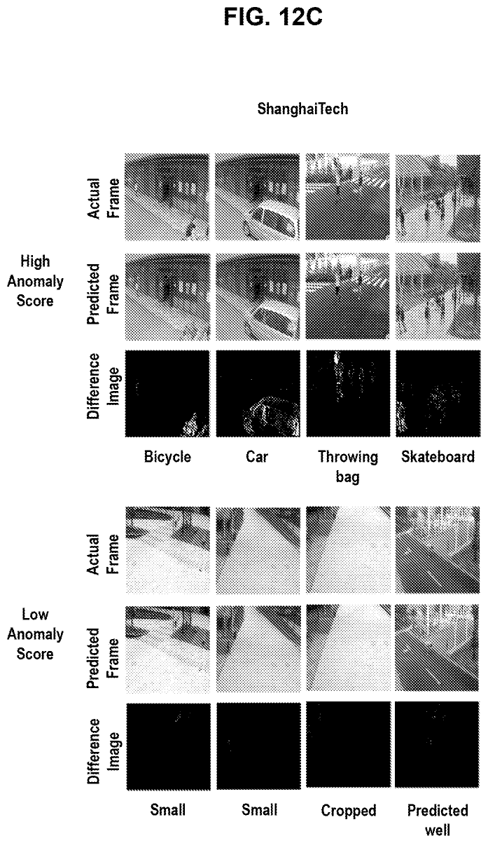

In order to analyze the abnormal situations that the method of the present disclosure infers well and other abnormal situations that the method does not infer well, the frames including the abnormal situations were classified into the frames resulting in high anomaly scores and the frames resulting in low anomaly scores. Further, for each frame, the actual frame, the predicted frame, and the difference between the actual frame and the predicted frame were visualized. FIGS. 12A-12C show examples of the actual frames, the predicted frames, and visualizations of the squared errors of the actual frames and respective predicted frames for the image frames containing abnormal situations. Specifically, FIG. 12A shows examples of the actual frames, the predicted frames, and visualizations of the squared errors of the frames for the images in the CUHK Avenue dataset. FIG. 12B shows examples of the actual frames, the predicted frames, and visualizations of the squared errors of the frames for the images in the UCSD Ped2 dataset. FIG. 12C shows examples of the actual frames, the predicted frames, and visualizations of the squared errors of the frames for the images in the ShanghaiTech Campus dataset.

As shown in FIGS. 12A-12C, the abnormality detecting method according to an exemplary embodiment of the present disclosure revealed high anomaly scores for rides such as a bicycle, an automobiles, and a skateboard; and people who perform unusual behaviors such as a person who dances, a person who throws an object, a person who runs, and a person who walks in a wrong direction. Meanwhile, the abnormality detecting method revealed low anomaly scores for stationary objects, dark objects, and partially visible objects such as an occluded object.

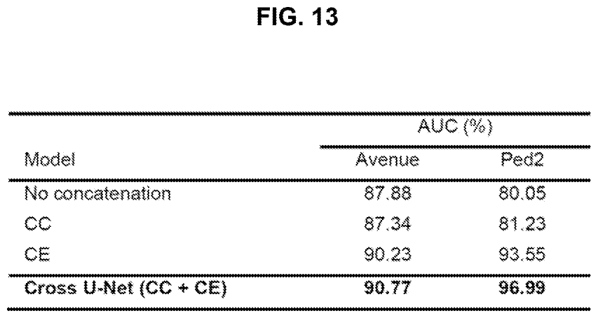

An ablation study was conducted to check whether the abnormality detecting method of the present disclosure using the Cross U-Net model shows a better performance than the methods using simplified models that do not employ some features of the Cross U-Net model. In the ablation study, compared were four models: the simplest model having no connection for the concatenation; a ‘CC’ model that employs cross connections between the contracting paths of two subnetworks to enable the exchange of the feature maps between the subnetworks and the concatenation of the feature maps received from the other subnetwork; a ‘CE’ model that employs skip connections between the contracting path and the expansive path of each subnetwork to enable the cropping of the feature maps in the contracting path and the concatenation of the feature maps in the expansive path; and the full Cross U-Net model. FIG. 13 shows the results of the ablation study. It can be seen in the drawing that the full Cross U-Net model revealed the best performance.

The apparatus and method according to an exemplary embodiment of the present disclosure may be implemented by computer-readable programs or codes stored in an intangible computer-readable storage medium readable by the monitoring camera or a monitoring control server. The computer-readable storage medium may be any type of data storage device capable of storing data that can thereafter be read by a computer system. In addition, the computer-readable recording medium may also be distributed over network-coupled computer systems so that the computer-readable program or code is stored and executed in a distributed fashion.

The computer-readable recording medium may include a hardware device specially constructed to store and execute a program instruction, for example, a ROM, a RAM, and a flash memory. The program instruction may include a high-level language code executable by a computer through an interpreter in addition to a machine language code made by a compiler.

Some aspects of the present disclosure have been described above in the context of a device but may be described using a method corresponding thereto. Here, blocks or the device corresponds to operations of the method or characteristics of the operations of the method. Similarly, aspects of the present disclosure described above in the context of a method may be described using blocks or items corresponding thereto or characteristics of a device corresponding thereto. Some or all of the operations of the method may be performed, for example, by (or using) a hardware device such as a microprocessor, a programmable computer or an electronic circuit. In some exemplary embodiments, at least one of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

Although the embodiments of the present disclosure have been described in detail, it should be understood that various substitutions, additions, and modifications are possible without departing from the scope and spirit of the present disclosure, and the scope of the present disclosure is limited by the claims and the equivalents thereof.

What is claimed is:

1. A method of detecting an abnormality in a series of temporally successive images, comprising:
generating a predicted current frame based on a previous frame temporally ahead of an actual current frame and a subsequent frame temporally behind the actual current frame;
calculating an anomaly score indicating a difference between the predicted current frame and the actual current frame; and
determining that an abnormality is included in the actual current frame when the anomaly score satisfies a predetermined condition.

2. The method of claim 1, wherein the previous frame is temporally ahead of the actual current frame by a plurality of frames, and the subsequent frame is temporally behind the actual current frame by the plurality of frames.

3. The method of claim 2, wherein the predicted current frame is generated by an artificial neural network comprising a first subnetwork receiving the previous frame as an input and a second subnetwork receiving the subsequent frame as an input,
wherein each of the first and second subnetworks comprises at least one layer stage, each layer stage having at least one convolutional layer.

4. The method of claim 3, wherein generating the predicted current frame comprises:
receiving, in a layer stage of the first subnetwork, a second feature map from a corresponding layer stage of the second subnetwork to concatenate the second feature map with a first feature map generated by the layer stage of the first subnetwork; and
receiving, in the corresponding layer stage of the second subnetwork, the first feature map from the layer stage of the first subnetwork to concatenate the first feature map with the second feature map generated by the corresponding layer stage of the second subnetwork.

5. The method of claim 3, wherein the artificial neural network is used after being trained in advance to generate the predicted current frame based on the previous frame and the subsequent frame in a normal situation where the actual current frame contains no abnormality.

6. The method of claim 1, wherein calculating the anomaly score comprises:
calculating a plurality of local anomaly scores by moving a window with respect to the actual current frame horizontally and vertically in a unit of a predetermined stride and performing a predetermined operation on pixel value differences between pixels in the predicted current frame and corresponding pixels in the actual current frame for an image frame portion overlapping the window at each window location; and
determining the anomaly score by averaging or summing the plurality of local anomaly scores calculated according to a movement of the window.

7. The method of claim 6, wherein each of the plurality of local anomaly scores is calculated by averaging or summing the pixel value differences between pixels in the predicted current frame and corresponding pixels in the actual current frame for the image frame portion overlapping the window.

8. The method of claim 6, wherein determining the anomaly score comprises:
determining the anomaly score by averaging only a predetermined number of local anomaly scores selected in an order of magnitude among the plurality of local anomaly scores calculated according to the movement of the window.

9. The method of claim 6, wherein a size of the window is set to decrease as the window moves upward with respect to the actual current frame.

10. The method according to claim 1, further comprising:
preprocessing the series of temporally successive images to convert to black-and-white images or adjust resolutions of the images before generating the predicted current frame.

11. An apparatus for detecting an abnormality in a series of temporally successive images, comprising:
a processor; and
a memory storing program instructions to be executed by the processor,
wherein the program instructions, when executed by the processor, causes the processor to:
generate a predicted current frame based on a previous frame temporally ahead of an actual current frame and a subsequent frame temporally behind the actual current frame;
calculate an anomaly score indicating a difference between the predicted current frame and the actual current frame; and
determine that an abnormality is included in the actual current frame when the anomaly score satisfies a predetermined condition.

12. The apparatus of claim 11, wherein the previous frame is temporally ahead of the actual current frame by a plurality of frames, and the subsequent frame is temporally behind the actual current frame by the plurality of frames.

13. The apparatus of claim 12, wherein the program instructions causing the processor to generate the predicted current frame comprises instructions to:
configure an artificial neural network comprising a first subnetwork receiving the previous frame as an input and a second subnetwork receiving the subsequent frame as an input; and
generate the predicted current frame by the artificial neural network,
wherein each of the first and second subnetworks comprises at least one layer stage, each layer stage having at least one convolutional layer.

14. The apparatus of claim 13, wherein the program instructions causing the processor to configure the artificial neural network comprises instructions to:
receive, in a layer stage of the first subnetwork, a second feature map from a corresponding layer stage of the second subnetwork and concatenate the second feature map with a first feature map generated by the layer stage of the first subnetwork; and
receive, in the corresponding layer stage of the second subnetwork, the first feature map from the layer stage of the first subnetwork and concatenate the first feature map with the second feature map generated by the corresponding layer stage of the second subnetwork.

15. The apparatus of claim 13, wherein the program instructions causing the processor to configure the artificial neural network comprises instructions to:
train the artificial neural network to generate the predicted current frame based on the previous frame and the subsequent frame in a normal situation where the actual current frame contains no abnormality.

16. The apparatus of claim 11, wherein the program instructions causing the processor to calculate the anomaly score comprises instructions to:
calculate a plurality of local anomaly scores by moving a window with respect to the actual current frame horizontally and vertically in a unit of a predetermined stride and performing a predetermined operation on pixel value differences between pixels in the predicted current frame and corresponding pixels in the actual current frame for an image frame portion overlapping the window at each window location; and
determine the anomaly score by averaging or summing the plurality of local anomaly scores calculated according to a movement of the window.

17. The apparatus of claim 16, wherein the program instructions causing the processor to calculate local anomaly scores comprises instructions to:
determine each of the plurality of local anomaly scores by averaging or summing the pixel value differences between pixels in the predicted current frame and corresponding pixels in the actual current frame for the image frame portion overlapping the window.

18. The apparatus of claim 16, wherein the program instructions causing the processor to determine the anomaly score comprises instructions to:
calculate an average of only a predetermined number of local anomaly scores selected in an order of magnitude among the plurality of local anomaly scores calculated according to the movement of the window.

19. The apparatus of claim 16, wherein a size of the window is set to decrease as the window moves upward with respect to the actual current frame.

20. The apparatus of claim 11, wherein the program instructions comprise instructions to:
perform a preprocessing of the series of temporally successive images to convert to black-and-white images or adjust resolutions of the images before generating the predicted current frame.
